(19) United States
(12) Patent Application Publication
(10) Pub. No.: US 2015/0283755 A1
(43) Pub. Date: Oct. 8, 2015

(54) Card Body with Variable Film Layers

(71) Applicant: TRÜB AG, Aarau (CH)

(72) Inventors: Christian Sailer, Safenwil (CH); Christoph Bächli, Brugg (CH)

(21) Appl. No.: 14/439,909

(22) PCT Filed: Oct. 31, 2013
(86) PCT No.: PCT/EP2013/072811

§ 371 Date: Apr. 30, 2015

(30) Foreign Application Priority Data
Nov. 1, 2012 (EP) 12190955.0

(51) Int. Cl. B29C 59/16; B32B 27/36; B32B 27/08; B32B 3/08; B42D 25/435; B42D 25/21

(52) U.S. Cl. CPC B29C 59/16; B42D 25/435; B42D 25/21; B32B 27/08; B32B 3/08; B32B 27/365; B32B 27/36; B42D 2033/30; B42D 2033/04; B32B 2425/00; B32B 2307/412; B29L 2009/00

(57) ABSTRACT

Disclosed is a method for producing a multi-layered data carrier (1), comprising at least one base layer (2), which has an upper side (3), and at least one transparent or translucent information layer (4), which is arranged on said upper side (3) and which contains personalised information (5a, 5b, 5c), the information layer (4) extending preferably entirely over the base layer (2), characterised in that the information layer (4) has at least one modified portion (6) and at least one unmodified portion (7), the information layer (4) being different in the unmodified portion (7) to the modified portion (6) in respect of its processing properties, and in that the information layer (4) is provided with personalised information (5a, 5b, 5c) in a personalisation step using at least one processing means (8, 9), the modified portion (6) of the information layer (4) reacting differently to the processing by the at least one processing means (8, 9) than the unmodified portion (7), whereby the information (5a) in the modified portion (6) is represented differently than the information (5b) in the unmodified portion.

### TECHNICAL FIELD

The present invention relates to a method for producing a multi-layer data carrier according to the preamble of claim 1 and a data carrier, produced according to the method according to claim 14.

### PRIOR ART

The prior art has disclosed data carriers, such as e.g. identification cards as ID cards or identification pages in personal identification documents. Such data carriers store information, such as personalized information relating to the document carrier.

So that a document body is made receptive to e.g. a specific personalization method, it is known that the unmanufactured films used for the production of the document body must be modified accordingly.

By way of example, the prior art has disclosed the practice of equipping the transparent card films for document bodies, which are provided for personalization by laser blackening, with IR-radiation absorbing additives, which ensure a targeted and controlled carbonization of the card films.

Moreover, document bodies which are provided for the personalization by means of thermal printing methods are known. If the raw material is not suitable for a specific thermal printing personalization method due to the chemical composition thereof, the prior art discloses the practice of providing the films, which are used as the upper ply in the document body, with a receptive layer over the whole area thereof. The application of this layer is generally performed as a final production step in the film production at the supplier of the film.

The whole-area application of corresponding layers is advantageous in that a data carrier can be produced in a very simple manner. However, the layers influence the personalization method, which e.g. leads to lack of color quality in the personalized regions. Moreover, certain personalization methods are even prevented by certain layer properties.

### SUMMARY OF THE INVENTION

Proceeding from this prior art, the present invention is based on the object of specifying a production method for a data carrier which overcomes the disadvantages of the prior art. In particular, the method should allow the production of a data carrier which has high quality personalization, in particular a superior print image, in all regions.

This object is achieved by the method for producing a multi-layer data carrier according to claim 1. Such a multi-layer data carrier substantially comprises at least one base layer with an upper side and at least one transparent or translucent information layer arranged on said upper side and comprising personalized information, wherein the information layer preferably extends completely over the base layer. The information layer has at least one modified portion and at least one unmodified portion, wherein the information layer is different in the unmodified portion from the modified portion in terms of the processing properties thereof. Within one step of personalization, at least one processing means is used to provide personalized information to the information layer, wherein the modified portion of the information layer reacts differently than the unmodified portion to the processing by the at least one processing means, as a result of which the information in the modified portion is represented differently from the information in the unmodified portion.

When using a first processing means, which is provided for the material properties of the unmodified portion, and when using a second processing means, which is embodied differently from the first processing means and which is provided for the material properties of the modified portion, the data carrier can be personalized in such a way that the negative effects mentioned at the outset do not occur. Consequently, each of the portions is therefore personalized with the processing means provided therefor, as a result of which the personalization has a high quality appearance. Moreover, the layer setup in the modified portion does not influence the layer setup in the unmodified portion and vice versa, which is likewise beneficial to the appearance of the data carrier.

However, the different portions can also be personalized differently by means of the same processing means, as a result of which the information is then represented differently in the various portions. This is advantageous in that a different personalization is providable by way of the same processing means.

Compared to card bodies modified over the whole area thereof, in which the whole area is modified, the modification of portions enables greater flexibility during the personalization. The whole-area modification can have disadvantageous effects on other document-relevant properties, particularly in view of specific personalization methods.

Preferably, the processing means is a laser with a defined wavelength, wherein the modified portion absorbs light of said wavelength, and wherein the unmodified portion is transmissive to light of said wavelength. Thus, the laser light cannot pass through the information layer in the modified portion, but can pass through it in the unmodified portion.

Preferably, during the step of the personalization by said laser, which can also be referred to as a first laser, the personalized information on the upper side of the information layer is engraved by material ablation in the modified portion as a result of the absorbing property thereof. Thus, the information becomes perceivable by touch. In the unmodified region, the first laser changes the color of the information layer during the step of the personalization in the region of the upper side of the base layer due to energy absorption at the upper side of the opaque base layer, wherein the personalized information is depicted by the color change. The color change is, in particular, a blackening.

The information can have a differently perceivable embodiment using a single processing means. This therefore enables a particularly efficient production of a data carrier.

In a development of the invention, said laser is a first laser with a first wavelength. The processing means, in addition to the first laser, comprises at least one second laser with a second wavelength, wherein the modified portion absorbs light at the first wavelength and wherein the unmodified portion is transmissive to light of the first wavelength and/or the second wavelength. According to this development, the data carrier is thus personalized using a first laser and a second laser with a different wavelength. Use can likewise be made of further lasers with further different wavelengths.

In one development of the invention, the information layer comprises a laser-activatable additive which, during the step of personalization, is modifiable by the second laser in terms of color, wherein the additive is preferably present in the modified portion and in the unmodified portion.

It is possible to provide a plurality of different information representation types in both the modified region and unmodified region during simultaneous personalization with the first laser and with the second laser. In the modified region, the first laser provides the engraving on the upper side and the interior of the information layer is changed in terms of color by the second laser. In the unmodified region, the information layer is changed by the first laser in terms of color in the region of the base layer due to the energy absorption and the interior of the information layer is changed in terms of color by the second laser.

Under observation using light in the visible spectral range, all information can be identified. Under observation using light with a wavelength that is absorbed by the modified portion, the information present under the modified portion in the information layer cannot be identified, which is a further security feature.

The first wavelength particularly preferably is a wavelength in the ultraviolet range and, in particular, lies at 254 nm or 355 nm. The second wavelength particularly preferably lies in the infrared range, in particular at 1064 nm or 10.6 μm.

The modified portion is preferably provided in a step of modification,
which step comprises a placement of at least one film part absorbing light of the first wavelength onto the information layer, which film part is then connected, in particular fused or adhesively bonded, to the base layer and the information layer within a step of connection, or
which step comprises an insertion of a film part absorbing light at the first wavelength into a cavity in the information layer, which film part is then connected, in particular fused or adhesively bonded, to the base layer and the information layer within a step of connection, or
which step comprises an application of a material, in the dissolved state, absorbing light at the first wavelength by way of a printing method or the like, or
which step comprises an application of a color absorbing light of the first wavelength.

Preferably, when seen in cross section, the information layer comprises one modified layer in the modified portion, said modified layer lying in or on the information layer at a distance from the base layer such that a further layer extends between the modified layer and the base layer. The modified layer is an absorption layer, which absorbs light from the first processing means and which is transmissive to light of the second processing means such that the further layer situated between the modified layer and the base layer can be personalized by the second processing means. Here, the modified layer and the further layer are part of the information layer, wherein the further layer particularly preferably consists of the same material as the information layer in said unmodified portion.

In an alternative embodiment, the information layer comprises a modified layer in the modified portion, said modified layer lying on the base layer and extending completely through the information layer from the base layer. This embodiment is particularly well-suited for processing with the first laser.

In a development of the invention at least one region fluorescing light of the first wavelength is arranged in the information layer, preferably below the modified portion. Within the step of processing the modified portion, the latter is ablated by means of the processing means in such a way that the ablated regions become visible in said film region under illumination with light at the first wavelength.

In an alternative embodiment, the processing means is a printer, in particular a transfer printer, retransfer printer, thermal sublimation printer, inkjet printer or the like, wherein the color substrate penetrates the modified portion, is absorbed on the surface thereof, or engages in adhesive interaction with the surface thereof, and wherein the color substrate does not engage in interaction with the unmodified portion.

A data carrier produced according to the method according to the invention comprises at least one base layer with an upper side and at least one transparent or translucent information layer arranged on said upper side and comprising personalized information, wherein the information layer preferably extends completely over the base layer. The information layer has at least one modified portion and at least one unmodified portion, wherein the information layer is different in the unmodified portion from the modified portion in terms of the processing properties thereof, and wherein, within one step of personalization, personalized information is providable to the information layer by means of at least one processing means. The modified portion of the information layer reacts differently than the unmodified portion to the processing by the processing means, as a result of which the information in the modified portion is represented differently from the information in the unmodified portion.

The information layer can be a single layer or be put together from a plurality of layers.

Preferably, the data carrier is an identification card, a page of a passport, a credit card, a security paper, a security document or the like.

Further embodiments are specified in the dependent claims.

### BRIEF DESCRIPTION OF THE DRAWINGS

Preferred embodiments of the invention are described below on the basis of the drawings, which merely serve for explanatory purposes and are not to be construed as being restrictive. In the drawings:

FIG. 1 shows a schematic view of a data carrier;

FIG. 2 shows a schematic sectional view through the data carrier according to FIG. 1 during processing with a processing means;

FIG. 3 shows a schematic sectional view through the data carrier according to FIG. 1 during processing with two different processing means;

FIG. 4 shows a layer setup of a first embodiment of the data carrier according to FIG. 1 in the non-connected state; and

FIG. 5 shows a layer setup of a second embodiment of the data carrier according to FIG. 1 in the non-connected state.

### DESCRIPTION OF PREFERRED EMBODIMENTS

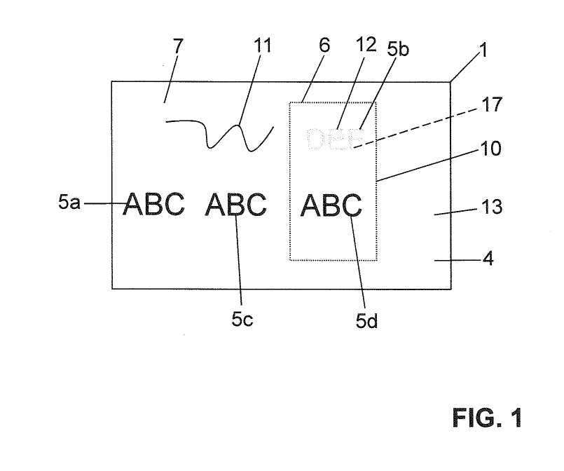

FIG. 1 shows a schematic plan view of a data carrier 1. From this plan view, it is possible to identify that the data carrier 1 produced by the method according to the invention has different portions. Here, the data carrier 1 has a modified portion 6 in the form of a rectangle and an unmodified portion 7. In this case, the unmodified portion 7 surrounds the modified portion 6. The arrangement and geometric embodiment of the portions 6, 7 can be arbitrary. Personalized information 5a, 5b, 5c and 5d is stored on the data carrier 1, in particular introduced into, and/or applied onto, the data carrier 1, both in the modified region and in the unmodified region 7. Here, the instances of personalized information 5a, 5b, 5c and 5d are denoted by the letters “ABC” and “DEF”. By way of example, the personalized information 5a, 5b, 5c and 5d can include the name of a person, nationality, date of birth, the number of the data carrier, or else an image, such as a portrait of a person. Other information is likewise conceivable.

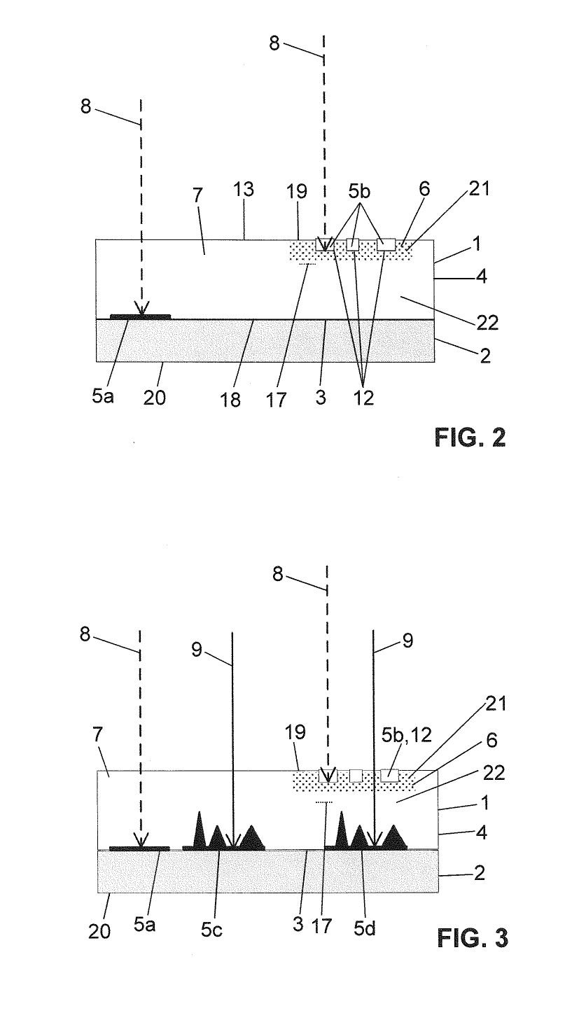

FIG. 2 shows a schematic sectional view through the data carrier according to FIG. 1. FIG. 2 shows the information 5b in the modified portion 6 and the information 5a in the unmodified portion 7. FIG. 3 likewise shows a sectional illustration through the data carrier according to FIG. 1, wherein, additionally in this case, the personalized information 5d is shown in the modified portion 6 and the personalized information 5c is shown in the unmodified portion 7.

It can be easily identified from the sectional illustrations in FIGS. 2 and 3 that the modified portion 6 and the unmodified portion 7 form an integral component of the information layer 4. In respect of the layer setup, the unmodified portion 7 substantially comprises the information layer 4. The modified portion comprises at least two different layers, namely a modified layer 21 and a further layer 22 lying below the modified layer 21. The modified portion 6 is provided by the modified layer 21. The further layer 22 is provided by the information layer 4 and comprises the same material as the information layer 4. Here, the materials of the two layers 21, 22 preferably differ from one another.

The information layer 4 can consist of one layer or a plurality of individual layers which are connected to one another.

Thus, a data carrier can be provided by the way of the present invention, in which locally restricted regions, i.e. the modified portion 6, have modified material properties compared to the employed base material of the information layer 4. However, the materials are preferably of the same type or compatible with one another. For the data carrier 1, use is preferably made of plastics, in particular polycarbonate, PVC, amorphous polyesters and/or copolyesters (A-PET, PET-G) and/or semi-crystalline polyesters (PET, boPET) or mixtures thereof.

An exemplary setup of the data carrier 1 is described on the basis of FIGS. 2 and 3. The data carrier 1 comprises at least one base layer 2 with an upper side 3. Furthermore, at least one information layer 4 is arranged on the upper side 3. The information layer 4 is embodied to be transparent or translucent to the human eye in the visible spectral range and extends completely over the base layer 2. With a lower side 18, the information layer 4 rests on the upper side 3 of the base layer 2 and said information layer is exposed on an upper side 13 lying opposite to the lower side 18. As mentioned above, the information layer 4 can consist of one or more layers, with in that case a plurality of information layers 4 being present. The personalized information 5a, 5b, 5c and 5d can be identified from the direction of the upper side 13.

The information layer 4 has the at least one modified portion 6 and the at least one unmodified portion 7. In this case, the modified portion 6 differs from the modified portion 7. Thus, in terms of the processing properties thereof, the information layer 4 differs from the modified portion 6 in the unmodified portion 7. The modified portion 6 in this case comprises the two layers 21 and 22.

The base layer 2 is preferably embodied as an opaque layer. In some embodiments, it is also feasible for the base layer 2 also to be embodied in a transparent or translucent manner.

The method for producing the multi-layer data carrier 1 comprises a step of personalization using at least one processing means 8, 9. In FIGS. 2 and 3, the effect of the processing means is depicted by arrows 8, 9. During this step, the information layer 4 is provided with the personalized information 5a, 5b and/or 5c. Here, each data carrier 1 to be produced includes different information. In this case, the modified portion 6 of the information layer 4 reacts differently to the processing by the at least one processing means 8, 9 than the unmodified portion 7. As a result of this, the information 5a, 5b in the modified portion 6 is represented differently from the information 5a, 5c in the unmodified portion.

The processing means 8, 9 is preferably a laser, which causes a material conversion in and/or on the information layer such that the information 5a, 5b, 5c becomes visible, in particular to the human eye, under observation in the visible spectral range. By way of example, a material conversion is understood to mean a targeted carbonization of parts of the information layer 4 or a controlled material ablation of the information layer 4.

Particularly preferably, the processing means 8 is a first laser with a first wavelength λ₁ and the processing means 9 is a second laser with a second wavelength λ₂. In this case, the two wavelengths λ₁ and λ₂ differ from one another. The first laser 8 is preferably an ultraviolet laser and the second laser 9 is preferably an infrared laser. The first wavelength λ₁ preferably lies at 254 nm or 355 nm and the second wavelength λ₂ preferably lies at 1064 nm or 10.6 μm.

FIG. 2 now shows the processing of the data carrier 1 using the first laser 8, which serves for providing the information 5a and 5b. In this case, the modified portion 6 is embodied in such a way that the latter absorbs the light of the first wavelength λ₁. Here, the modified layer 21 can also be referred to as absorption layer 21. Thus, in the case of the ultraviolet laser, the modified portion 6 is a region absorbing light in the ultraviolet range. The unmodified portion 7 is transmissive to light of the first wavelength λ₁ and/or light at the second wavelength λ₂. Thus, in the unmodified portion 7, the light from the processing means 8 can reach the upper side 3 of the base layer 2 through the information layer 4. In the case of processing by the first processing means, here the UV laser 8, there is an energy absorption in the unmodified region 7 in the region of the upper side of the opaque base layer 2, as a result of which the information layer 4 changes in terms of color in the region of the upper side 13 of the opaque base layer 2 or in the region of the lower side 18 of the information layer 4. In particular, there is blackening. As a result of this, the personalized information 5a is produced and made visible. In the modified portion 6, which is embodied to absorb light of the first processing means 8, there is energy absorption in the region of the upper side 13. As a result of this, the personalized information 5b is engraved on the upper side 13 of the information layer 4. Thus, the information 5b extends from the upper side into the information layer 4, here into the absorption layer 21, as a result of which the information 5b is stored as information perceivable by touch.

Thus, in respect of FIG. 2, it is possible to say that the modified portion 6 of the information layer 4 reacts differently to the processing by the UV laser 8 than the unmodified portion 7, as a result of which the information 5b in the modified portion 6 is represented differently from the information 5a in the unmodified portion 7.

During the step of personalization by the first laser 8, the personalized information 5b is engraved on the upper side 13 by material ablation in the modified portion 6 on account of the absorbing property thereof. In the unmodified portion 6, the personalized information 5a is represented by a color change in the region of the upper side 3 of the base layer 2. Thus, the appearance of the information 5b provided as an engraving differs from the appearance of the information 5a provided as blackening. Thus, the data carrier 1 according to the embodiment shown in FIG. 1 has two different representations of the information.

FIG. 3 now explains the processing with more than one processing means, here with two different processing means 8, 9. The data carrier 1 in accordance with FIG. 3 is substantially identical to the data carrier according to FIG. 2. In this case, the first processing means 8 is identical to the processing means which was already explained on the basis of FIG. 2. Thus, this relates to a UV laser, by means of which the information 5b and 5a is introducible. The second processing means 9 differs from the first processing means 8, as is likewise already explained above. The second processing means 9 is preferably a laser which provides light in the infrared spectral range. In other words, the wavelength of the light of the second laser lies in a region which is not absorbed by the modified portion 6. Thus, the modified portion 6 is transmissive to the light of the second laser, i.e. preferably transparent, as a result of which the modified portion 6 of the information layer 4 can likewise be personalized. As seen in relation to the layer setup, the information lies in the layer 22 below the absorption layer 21 and over the surface 3 of the base layer 2.

Preferably, the information layer 4 in this case is provided with a laser-activatable additive, which enables a color change under the action of laser light in the infrared range. In this case, the color change can be varied, the color changes particularly preferably in such a way that, in this case, it extends upwardly in the information layer 4, as seen from the base layer 2, from the lower side 18 toward the upper side 13. However, a color change that does not extend in said direction is also possible. In respect of the wavelength of the light of the second processing means 9, the modified portion 6 is formed in a transparent manner. Consequently, the IR laser will be able to pass through the modified portion 6 and be able to introduce the information 5a into the information layer 4 like in the unmodified portion 7.

The information 5c in the modified portion 6 and the information 5d in the unmodified portion 7 is therefore depicted the same under observation with light in a spectral range outside of the spectral range absorbed by the modified portion 6. By way of example, such light is normal daylight. Under observation with light in a spectral range within the spectral range that is absorbed by the modified portion 6, the information in the modified portion 6 cannot be identified because the light is absorbed in the modified portion 6. As a result of this, the information 5a and 5c can then be depicted differently.

Thus, the information layer 4 comprises a laser-activatable additive which, during the step of personalization by the second laser 9, causes a color change in the layer, wherein the additive is preferably present both in the modified portion 6 and in the unmodified portion 7. Such additives are known from the prior art.

The modified portion 6 is provided in a modification step during the production of the data carrier. The modification step can be carried out in different ways.

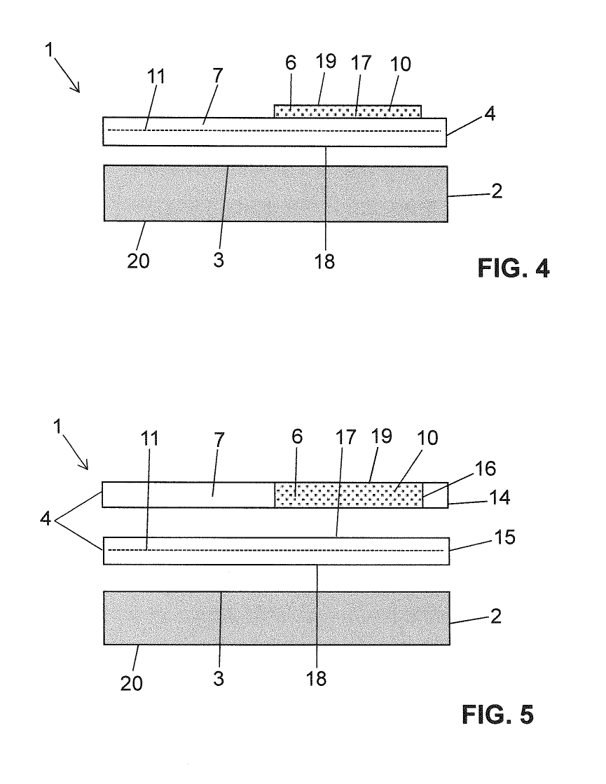

According to a first embodiment, which is shown in FIG. 4, the step of modification comprises a placement of at least one film part 10 absorbing light of the first wavelength λ₁ onto the upper side 13 of the information layer 4. Then, the film part 10 is connected, in particular fused or adhesively bonded, to the base layer 2 and the information layer 4 during a connection step. Particularly preferably, the connecting is laminated by laminating film part, base layer 2 and information layer 4 together.

The at least one film part 10 is arranged on the information layer 4 in relation to the base layer 2 during the modification step, wherein the film part 10 is in planar contact with the information layer 4 prior to the connecting, in particular the laminating.

During the connection by way of lamination, the film part 10 is introduced into the information layer 4. The upper side 19 of the film part 10 then lies flush with the upper side 13 of the information layer such that the information layer 4 or the data carrier has a continuous planar upper side 13. Thus, the film part 10 is embedded into the information layer 4. This is shown in FIGS. 2 and 3.

Here, the film part 10 has a thickness which is less than the thickness of the information layer 4 such that part of the information layer 4, i.e. the layer 22, still extends between the base layer 2 and the film part 10. However, this part of the information layer 4 then is only still receptive to the processing means which are not absorbed by the film part 10, which provides the absorption layer 21.

According to a second embodiment, which is shown in FIG. 5, the modification step comprises an insertion of a film part 10 which absorbs light of the first wavelength λ₁ into a cavity 16 in the information layer 4, which film part 10 is then connected, in particular fused or adhesively bonded, to the base layer 2 and the information layer 4 during a connection step. Particularly preferably, film part, base layer 2 and information layer 4 are laminated together.

By way of example, as shown in FIG. 5, the cavity can be formed by a cutout in a first film layer 14 of the information layer 4, said first film layer then resting on a second film layer 15. These two film layers 14, 15 are then connected together, in particular laminated, to form the information layer 4. The above-described further layer 22 is then provided by the film layer 14.

In this case, the second film layer 15 extends over the whole base layer and constitutes the information layer under the film part 6 in the connected state. However, the part of the information layer 4 under the film part 10 then is only still receptive to the processing means which are not absorbed by the film part 10.

In an alternative embodiment (not shown here), the film layer 14 comes directly to rest on the upper side 3 of the base layer 2, with the insertion part then also coming into contact with the upper side 3. This embodiment is particularly suitable for processing with the first laser.

In all embodiments described herein, the information layer 4 can be provided by one or two or a plurality of plies, which are then connected to one another.

According to further embodiments, the modification step comprises an application of a material, in the dissolved state, absorbing light of the first wavelength λ₁ by way of a printing method or the like, or an application of a color absorbing light of the first wavelength λ₁.

In a particularly preferred embodiment, a region 17 fluorescing light at the first wavelength λ₁ is arranged in the information layer 4, preferably below the modified portion 6. The fluorescing region 17 can be arranged at any point. Particularly preferably, the fluorescing region 17 is part of the security print 11 or lies substantially directly below the modified layer 21 or adjoins the latter. During the step of processing the modified portion 6, the latter is ablated by means of the processing means 8 in such a way that the ablated regions become visible in said film region under illumination with light of the first wavelength λ₁. Thus, the engraving produced by the first processing means 8 has a depth which at least partly removes or completely removes the absorbing layer such that it becomes visible under illumination with light of the first wavelength λ₁. A further security feature can be created in this manner.

Particularly preferably, at least one security print 11, which preferably assumes the form of guilloches, is present in or on the information layer 4. When the security print 11 comes to rest within the information layer 4, said security print is printed onto the corresponding layer prior to the lamination of individual layers to form the information layer 4.

The modified portion 6 extends over the information layer 4 in predefined regions. The form of the modified portion 6 can be arbitrary in this case.

In an alternative embodiment, the modified portion 6 extends over the information layer 4 in randomly arranged regions.

In respect to the thickness of the individual layers, it should be noted that the information layer 4 preferably has a thickness of approximately 200 μm and the base layer 2 preferably has a thickness of approximately 250 μm.

In respect to the cross sections shown in FIGS. 2 to 5, it should still be noted that the data carrier can still be complemented by further layers on the lower side 20 of the base layer. By way of example, this can be with a layer setup as seen from the upper side 18.

### LIST OF REFERENCE SIGNS

1 Data carrier

2 Base layer

3 Upper side

4 Information layer

5a, 5b, 5c, 5d Personalized information

6 Modified portion

7 Unmodified portion

8 First processing means; UV laser

9 Second processing means; IR laser

10 Film part

11 Security print

12 Engraving

13 Upper side

14 First film layer

15 Second film layer

16 Cavity

17 Fluorescing region

18 Lower side

19 Upper side

20 Lower side

21 Modified layer, absorption layer

22 Layer

1-16. (canceled)

17. A method for producing a multi-layer data carrier comprising at least one base layer with an upper side and;
at least one transparent or translucent information layer arranged on said upper side and comprising personalized information, wherein the information layer preferably extends completely over the base layer,
wherein the information layer has at least one modified portion and at least one unmodified portion, wherein the information layer is different in the unmodified portion from the modified portion in terms of the processing properties thereof, and
wherein by means of a step of personalization, at least one processing means is used to provide personalized information to the information layer,
wherein the modified portion of the information layer reacts differently than the unmodified portion to the processing by the at least one processing means, as a result of which the information in the modified portion is represented differently from the information in the unmodified portion.

18. The method as claimed in claim 17, wherein the processing means is a laser with a wavelength, wherein the modified portion absorbs light of the wavelength, and wherein the unmodified portion is transmissive to light of the wavelength.

19. The method as claimed in claim 18, wherein said laser is a first laser with a first wavelength and wherein the processing means, in addition to the first laser, comprises a second laser with a second wavelength, wherein the modified portion absorbs light of the first wavelength and wherein the unmodified portion is transmissive to light of the first wavelength and/or the second wavelength.

20. The method as claimed in claim 19, wherein
during the step of personalization, the personalized information on the upper side is engraved by material ablation by the first laser in the modified portion on account of the absorbing property thereof and/or,
during the step of personalization, the first laser modifies the color of, in particular blackens, the information layer in the region of the upper side of the base layer as a result of the energy absorption on the upper side of the opaque base layer, wherein the personalized information is depicted by the color change or the blackening, and/or
wherein the information layer comprises a laser-activatable additive which, during the step of personalization, is modifiable by the second laser in terms of color, wherein the additive is preferably present in the modified portion and in the unmodified portion.

21. The method as claimed in one of claim 20, wherein the information layer comprises a modified layer in the modified portion, said modified layer lying in or on the information layer at a distance from the base layer such that a further layer extends between the modified layer and the base layer, wherein the modified layer is an absorption layer, which absorbs light from the first processing means and which is transmissive to light of the second processing means such that the further layer situated between the modified layer and the base layer can be personalized by the second processing means or such that the information layer comprises a modified layer in the modified portion, said modified layer lying on the base layer and extending completely through the information layer from the base layer.

22. The method as claimed in claim 19, wherein the first wavelength is a wavelength in the ultraviolet range, in particular at 254 nm or 355 nm, and wherein the second wavelength lies in the infrared range, in particular at 1064 nm or 10.60 μm.

23. The method as claimed in claim 17, wherein the modified portion is provided in a step of modification, which step comprises a placement of at least one film part absorbing light at the first wavelength onto the information layer, which film part is then connected, in particular fused or adhesively bonded, to the base layer and the information layer within a step of connection, or which step comprises an insertion of a film part absorbing light at the first wavelength into a cavity in the information layer, which film part is then connected, in particular fused or adhesively bonded, to the base layer and the information layer within a step of connection, or which step comprises an application of a material, in the dissolved state, absorbing light at the first wavelength by way of a printing method or the like, or which step comprises an application of a color absorbing light of the first wavelength.

24. The method as claimed in claim 23,
wherein the at least one film part is arranged opposite the base layer on the information layer, wherein the film part is in planar contact with the information layer prior to lamination, or
wherein the information layer comprises at least two layers lying one above the other, wherein a first layer lies on the upper side of the base layer and a second layer lies on the first layer, wherein said cavity for receiving the film part is present in the second layer.

25. The method as claimed in claim 17, wherein at least one region fluorescing light of the first wavelength is arranged in the information layer, preferably below the modified portion, wherein, within the step of processing the modified portion, the latter is ablated by means of the processing means in such a way that the ablated regions become visible in said film region under illumination with light of the first wavelength.

26. The method as claimed in claim 17, wherein at least one security print, which preferably assumes the form of guilloches, is present in the information layer.

27. The method as claimed in claim 17, wherein the modified portion extends over the information layer in predefined regions or wherein the modified portion extends over the information layer in randomly arranged regions.

28. The method as claimed in claim 17, wherein the base layer, the information layer and the at least one film part, possibly the top layer, consist of a thermoplastically processable plastic and are connected to one another in a connection step, in particular in a step of laminating under the effect of pressure and temperature.

29. The method as claimed in claim 17, wherein the processing means is a printer, in particular a transfer printer, retransfer printer, thermal sublimation printer, inkjet printer or the like, and wherein the color substrate penetrates the modified portion, is absorbed on the surface thereof, or engages in adhesive interaction with the surface thereof, and wherein the color substrate does not engage in interaction with the unmodified portion.

30. A data carrier comprising:
at least one base layer with an upper side and
at least one transparent or translucent information layer arranged on said upper side and comprising personalized information, wherein the information layer preferably extends completely over the base layer,
wherein the information layer has at least one modified portion and at least one unmodified portion, wherein the information layer is different in the unmodified portion from the modified portion in terms of the processing properties thereof, and
wherein within the scope of a step of personalization, personalized information is providable to the information layer by means of at least one processing means, wherein the modified portion of the information layer reacts differently than the unmodified portion to the processing by the processing means, as a result of which the information in the modified portion is represented differently from the information in the unmodified portion.

31. The data carrier as claimed in claim 30, wherein the data carrier is produced according to the method of claim 17.

32. The data carrier as claimed in claim 30, wherein the information layer comprises a modified layer in the modified portion, said modified layer lying in or on the information layer at a distance from the base layer such that a further layer extends between the modified layer and the base layer, wherein the modified layer is an absorption layer, which absorbs light from the first processing means and which is transmissive to light of the second processing means such that the further layer situated between the modified layer and the base layer can be personalized by the second processing means.

33. The data carrier as claimed in claim 30, wherein it is an identification card, a page of a passport, a credit card, a security paper, a security document or the like.
